(19) United States
(12) Patent Application Publication
(10) Pub. No.: US 2020/0408241 A1
(43) Pub. Date: Dec. 31, 2020

(54) Barrel Nut With Helical Wire Insert

(71) Applicant: Donald Wayne Rice, Ripley, NY (US)

(72) Inventor: Donald Wayne Rice, Ripley, NY (US)

(73) Assignee: SkyClimber Fasteners LLC

(21) Appl. No.: 15/595,620

(22) Filed: May 15, 2017

(51) Int. Cl. F16B 39/34; F16B 37/04

(52) U.S. Cl. CPC F16B 39/34; F16B 37/047

(57) ABSTRACT

The present disclosure relates to an improved barrel nut and other related threaded fasteners that incorporate a helical thread insert. The Helical thread insert can be used as part of a fastener system to lock the fastener in place. In a preferred embodiment, the locking feature is configured as a barrel nut and is targeted to be utilized in vehicles, such as in aircraft.

### CROSS-REFERENCE TO RELATED APPLICATIONS

This application claims priority to U.S. Provisional Patent Application Ser. No. 62/405,827 filed Oct. 7, 2016, U.S. Provisional Patent Application Ser. No. 62/335,915 filed May 13, 2016, and U.S. Provisional Patent Application Ser. No. filed Apr. 15, 2016, the disclosures of which are hereby incorporated by reference.

### STATEMENT REGARDING FEDERAL GRANTS

Not Applicable.

### BACKGROUND OF THE INVENTION

The present disclosure relates to a helically coiled wire insert that is used as part of a fastener system to lock a fastener in place. In a preferred embodiment, the locking feature fastener system is a barrel nut and is utilized in vehicles, such as in aircraft.

Locking fasteners are widely used in attaching equipment to underlying structures, particularly to structures subject to movement and vibration. For purposes of this disclosure, locking fasteners include positive locking fasteners, such as those fasteners that provide a mechanical barrier to movement of a fastener, such as through a positive locking cotter pin placed through a cross bore. Locking fasteners also include threaded fasteners that function to retard the backing off of a tightened threaded fastener to a specified reverse torque, such as a specified “breakaway torque” and a reverse “prevailing torque.”

Locking fasteners such as barrel nuts are widely used in fixed wing, rotating wing, and moving surface aircraft, such as attaching engines to wings and on occasion to an aircraft fuselage. Locking fasteners in general are commonly specified for installations in vehicles, such as automobiles, trucks, trains, military equipment and vehicles, defense systems, spacecraft and delivery implements and other commercial mechanical equipment, (e.g., tractors, earth moving equipment, conveyor systems and yard equipment.) In particular, aircraft jet engines are often attached to the airframe with barrel nuts that include a locking feature. In addition, the same or similar fasteners are used in a variety of situations, such as industrial and farm equipment and other equipment where vibration and motion control is required.

In the aviation industry, it is vital that any connection fastening two structures be secure and reliable. The use of various high grade nuts and bolts throughout the aircraft ensures security and reliability of fastening and allow for an additional margin of safety assurance through their use.

In addition to the requirement for safety, security and reliability is a potentially countervailing requirement that aircraft minimize the combined weight of fasteners. In addition, use of fasteners, including efficiency of installation, removal and renewal is an important consideration. Another concern is the accumulated weight of fasteners and the efficiency of the use of fasteners in a given joint. When a fastener attachment is required within a large structural joint, designers often avoid using a bolt spanning the full width of the structural piece. For these applications and others, barrel nuts are typically used. Examples of these types of connections include connecting the landing gear to the fuselage, the engine pods to the wings, and nacelle and fuel tank attachments.

A barrel nut provides a self-wrenching mechanism that allows for the creation of an attachment point within a larger structural unit. Due to the positioning of the joint, it becomes impossible to apply a wrench or other tool to the nut itself, thereby making the use of a standard nut impossible. The barrel nut is inserted along a cavity, such as a cylindrical cavity, or tubular member such as a wing spar, and a threaded shaft, i.e. a stud or bolt, is passed through an opposed hole in the structural member. Thus, a barrel nut is held in a longitudinally extended cylindrically shaped cavity that prevents the rotation of the barrel nut, and a threaded shaft of a fastener passes through the wall of the cavity and into the thread bore of the barrel nut. As the threaded shaft is inserted the act of twisting such a bolt into the barrel nut causes a self-wrenching effect. This removes the necessity for a secondary tool to hold the nut in order to properly torque the junction of the connecting joint, and allowing for a secure fastening within the larger extended structure.

Another group of features in barrel nuts includes the provision for locking mechanisms with the nut body that are used to ensure the bolt does not release from the nut after being torqued to specification. Two common types of locking mechanisms include the non-metallic lock ring disk and the crimped lock nut. These are both commonly considered “prevailing torque” locking nuts. In addition, there are positive locking nuts, which provide a physical barrier to the backing out (or off) of a nut. When used in aircraft, barrel nuts almost always are provided with a self-locking mechanism that provides for the bolt remaining properly secured to the nut, preventing loosening of the bolt through the application of directed force, vibration, or other forces. These locking mechanisms can be of a variety of styles, including those just described. Uncommonly barrel nuts are used without a locking feature.

The common versions of prevailing torque locking nuts with a non-metallic lock ring disk use a lock ring disk of synthetic polymer, generally a nylon or polyimide, that provides similar action as the crimped lock nut, but with different overall properties.

Machined locking rings of Vespel™ resilient material are commonly utilized for providing prevailing torque locking nuts, including barrel nuts, especially for large diameter, high strength or flight critical installations. Vespel™ inserts are made from a polyimide based material and are often used with locking or self-locking fasteners. Available fastener systems are generally less than fully acceptable because the available locking inserts are expensive and installation of a locking insert, such as a Vespel™ insert, during manufacture of the fasteners, is often difficult. An additional limitation in using such inserts is that the bolt component must be driven into the insert to maintain the specified torque tolerance even while introduced into an environment that imposes a wide range of temperatures and vibration patterns. Currently, one effective locking or retaining system available for aircraft use is a disk shaped collar made of Dupont Vespel™. Commonly Dupont Vespel SP polyimide components are machined or cut into a disk shape and then inserted as a collar adjacent to the distal exposed threads of a fastener nut. The seating of the lock ring disk is problematic, and requires reshaping of the nut during manufacture in order to retain the lock ring disk. The steps of manufacturing a prevailing torque fastener using a Vespel insert requires providing a disk seat, usually by machining, inserting the Vespel disk, followed by a crimping step to retain the Vespel disk within the disk seat.

Locking fasteners which use inserts such as resilient inserts formed of Vespel™ have many limitations. Importantly, such inserts are expensive, as the plastic material must be approved by OEM users and the proprietary material in Vespel™ cannot be substituted by unapproved alternatives from third parties. The use of resilient inserts also has many issues such as a) the inserts are easily-damaged during installation b) limitation on the ability to reuse resilient inserts for reinstallation of components, and c) the limitation to the shape of fasteners when using a resilient collar (lock ring disk). These current systems are generally limited, and could be substantially improved with an alternative substitute to a resilient insert locking fastener. Another disadvantage of existing systems is the limited number of cycles of insertion and removal that are within specified limits. Furthermore, there is an undesired inconsistency between locking torque values between the early cycles of use, and when the fastener is finally replaced.

Another existing type of locking nut fastener comprises a nut that has been provided with a thread bore that is a shape other than round, in particular, an oval thread barrel. One current method of creating an oval thread bore is to distort, or “crimp” a circular cross section nut bore to a specified torque, distorting the round cross section to an oval cross section. Such crimped fasteners can function as a prevailing torque locking fastener, but have a number of limitations. Certain specifications set limits for both prevailing torque and for break away torque. These limitations include the difficulty in starting the crimped nut on the thread of a bolt, due to the distortion of the circular cross section. Nuts which are crimped at the time of use may be essentially destroyed by improper or over crimping. Furthermore, it is difficult to reproducibly create a desired fastener that performs within a narrow desired range of prevailing torque. Another type of crimped fastener utilizes three-point crimping (usually used on a larger sizes of nuts). Theoretically more points for crimping are possible (for example four or more). In all of these fasteners, the amount of back-off resistance (i.e. the prevailing torque of the fastener) is difficult to control and lacks consistency between different lots of crimped fasteners, and between installation events or between different technician installers. See for instance, Barrett, R. T., “Fastener Design Manual,” NASA Reference Publication 1228, March 1990. During the manufacture of prevailing torque barrel nuts using a crimped nut, a necessary step is to deform the nuts by crimping. Every manufacturing lot must be tested to determine if samples fall within specifications. If the test samples selected from a given lot of aircraft fasteners fails specifications for either prevailing torque or break-away torque, then the entire manufacturing lot must be scrapped at substantial cost. It would be advantageous for fastener lots to have a reduced lot rejection rate, or to have an increased consistency in prevailing torque or break-away torque values.

With respect to barrel nuts, the threads of the nut are formed within the nut body of the barrel nut. For a mechanically crimped prevailing torque locking barrel nut fastener, at some step in installing the barrel nut, the chimney segment of the nut body is mechanically crimped to add the required prevailing torque resistance. The mechanical crimping is disadvantageous due to inconsistency of induced prevailing torque resistance, break away torque resistance, difficulty in controlling the crimping process (particularly when done as part of installation, at the work site) and the introduction of stress defects, such as microcracks, into the fastener. The rejection rate of crimped fasteners can be as much as 20%, or one of five lots being rejected for failing to meet specification. Moreover, other mechanical actions, such as machining different thread shapes, or a different threadbore shape are difficult and expensive to accomplish.

One supposed advantage of the non-metallic lock ring is the reusability of the part. For aerospace requirements, resilient material lock rings are required to remain within specification for a 15-cycle functional life. By way of example, one cycle represents installation of a fastener to its specified torque, followed by loosening and then full removal of the fastener. The reusability of resilient material lock rings is subject to variation based on the finish of the bolt as well as whether any lubricant is being used. One disadvantage of the resilient material lock ring is the effective range of temperatures over which the locking properties of the ring are within specification. While operable in a wide range of temperatures, a nylon lock ring is still limited to use in temperatures below 250° F., and the polyimide lock ring are limited to use in temperatures below 450° F. Where locking nuts are needed in conditions that routinely exceed 450° F., the resilient material forms of a prevailing torque locking ring is not suitable. Thus, when selecting a particular locking barrel nut for the particular installation, engineers must weigh reusability factors against limitations of the locking ring over temperature ranges.

Due to varying requirements of use, barrel nuts come with a variety of optional features. Two alternative features include floating and fixed barrel nut. The floating barrel nut is of a two-piece design with a free-floating nut body held within the casing (barrel) structure commonly referred to as the barrel nut's “cradle” or “saddle.” This floating (two piece) nut body allows for a greater tolerance in alignment of the inserted bolt with the barrel nut, as the requirement of precise alignment between the nut and bolt during insertion is reduced. Such floating barrel nuts provide for nearly equivalent performance to barrel nuts with fixed nut bodies but the accommodations required for a two-piece design introduce a higher likelihood of errors during the manufacturing process. The fixed, or non-floating, barrel nut provides a one-piece design that eliminates some of the manufacturing difficulties and allows for less waste due to rejection of parts that are not within specification. The fixed barrel nut however, is much more difficult to align when inserting a bolt, as the nut body has limited ability to shift position in order to accept the bolt as would be provided by a floating barrel nut. Therefore fixed barrel nuts require more precise alignment during installation.

While an important determination for selecting for barrel nuts depends on selecting a floating versus a fixed nut body, and the type of locking rings, additional variations are also desirable. The base metal forming the barrel nut body can be selected to accommodate differing applications of the barrel nut, such as a desire for increased corrosion resistance or to more suitably match the barrel nut body material to the material with which it will be mated. Typically, the existing barrel nuts thus described are routinely expected to be used with bolts with an Ultimate Tensile Strength (UTS) of 180 to 220 KSI. (KSI is an abbreviation for “thousand pounds per square inch.”) Currently, the use of bolts outside of this UTS range is disfavored, (and possibly forbidden) because out of specification fasteners could result in damage to the mated nut or bolt and possibly result in failure or damage to the assembly or structural unit. Moreover, the specification requirements for use in aircraft probably require meeting strength and cycle life standards for both nut body and for an insertable threaded shaft.

While an important determination for selecting barrel nuts depends on selecting a floating versus a fixed nut body, and the type of locking mechanism, additional variations are also desirable. The base metal forming the barrel nut body can be selected to accommodate differing applications of the barrel nut, such as a desire for increased corrosion resistance or to more suitably match the barrel nut body material to the material with which it will be mated. Typically, the existing barrel nuts thus described are routinely expected to be used with bolts with an Ultimate Tensile Strength (UTS) of 180 to 220 KSI. (KSI is an abbreviation for “thousand pounds per square inch.”) Currently, the use of bolts outside of this UTS range is disfavored, (and possibly forbidden) because out of specification fasteners could result in damage to the mated nut or bolt and possibly result in failure or damage to the assembly or structural unit. Moreover, the specification requirements for use in aircraft probably require meeting strength and cycle life standards for both nut body and for an insertable threaded shaft

The effective cost of the fasteners is another important consideration in the selection of a particular barrel nut. Barrel nuts vary widely in price, depending on nut material, finish, and locking ring material. Hundreds of barrel nuts may be used in the assembly of a single aircraft, with the cost of barrel nuts not insignificant relative to the cost of the aircraft considering the current cost of these fasteners. Thus, small marginal advantages in the process of manufacture can have a significant effect on the total cost of a project.

A variety of threaded inserts for placement within threadbores have been available for over 50 years. One example of a threaded insert was invented by the Heli-Coil Corporation of Long Island, N.Y. A “heli-coil” insert was generally utilized to repair damaged threads in a complex part, such as an engine block, that could not be easily be replaced or would not be reasonable to replace due to a single damaged thread. Heli-coil type inserts also are used as inserts in weak parent body materials to minimize the potential for thread damage. With heli-coil type inserts, the existing threads are drilled out and the hole is retapped for the threaded insert. After insertion of the threaded insert, the original thread geometry can be recreated by the insert. One example of the heli-coil type thread insert is disclosed in U.S. Pat. No. 2,607,259 by J. O. Forster, issued Aug. 19, 1952. Other suppliers of helical wire inserts include Kato Fastening Systems, Inc. of Newport News, VA, that sell “Coil Thread”™ inserts. While a wide variety of thread patterns may be used, depending on the requirements of a particular application, many helical wire inserts are provided to be compatible with “STI” or Standard Thread Insert threads. In use, helically coiled wire inserts can be formed to accept standardized Unified Coarse (UC) or Unified Fine (UF) threads that conform to National Bureau of Standards specification.

Another example of a threaded insert is the “Spiralock”™ fastener, available from Stanley Engineered Fastening of New Britain Connecticut. The Spiralock-type fastener provides an insert that serves to retain an inserted male fastener so long as the fastener is driven to have an assembly clamp load. Spiralock-type fasteners are not considered a prevailing torque locking fastener, because there is no locking action if the terminal torque requirement is not maintained. Thus, prior to the inventions disclosed herein there were currently no fasteners available or approved for use in aircraft that utilized a helically threaded insert to provide reliable threads or locking mechanisms.

There is a continuing need for specialized fasteners that function to retain a male thread through a range of insertion, even if a terminal torque is not maintained. In essence it is highly desirable for the nut, i.e., the female component of a threaded fastener, to be inhibited from backing off of the threaded shaft, i.e. the male fastener. Movement of either the male or female component(s) of a threaded fastener can be catastrophic, particularly when there is complete backing out, complete release of the fastener.

Despite the wide adoption of the currently available locking systems, there is much room for improvement. A more effective barrel nut is desirable that would increase the reusability cycle range, reduce the variation in locking torque across cycles, and maintain or extend the effective temperature range for use of a selected barrel nut. A barrel nut that can be manufactured in a more efficient or economical manner is also desirable.

Further, it is desirable to provide an insert that provides reusable threads, and an insert providing threads that are stronger than the parent material, and that increase the effective strength of parent material, thread insert, and fastener combination over the net strength of a fastener without the thread insert. A thread insert is expected to provide a larger effective diameter than the similar existing fasteners and thus provide an increase in the bearing area of the fastener, and an increase in ultimate tensile strength.

An improved fastener system is desired by manufacturers and retrofitters to reduce the cost of current fasteners, and it is also desirable to enable labor savings along with improved assembly processes, and improved maintainability, reparability, overhauling, fastener reliability and strength.

### BRIEF DESCRIPTION OF THE DRAWINGS

For a fuller understanding of the nature and advantages of the present invention, reference should be had to the following detailed description taken in connection with the accompanying drawings, in which:

FIG. 1 shows a perspective view of a fastener using the helical thread insert system;

FIG. 2 shows a series of views of an improved fastener;

FIG. 3 shows an alternative locking helical wire insert;

FIG. 4 shows a series of views of an improved locking barrel nut fastener;

FIG. 5 shows cross sections of manufacturing step views of the components of an improved fastener;

FIG. 6 shows an embodiment of barrel nuts for use in aircraft with composite wings;

FIG. 7 shows cross sections of alternative forms of barrel nuts; and

FIG. 8 shows an alternative embodiment of barrel nuts for use in aircraft.

### SUMMARY OF THE INVENTION

Disclosed is an improved barrel nut comprising a longitudinally extended barrel segment with a seat, such as a nut body or threadbore body seat; a thread bore body that is formed to be structurally compatible with the nut body seat of the barrel segment and the threadbore body is positionable within the seat. A thread bore is formed within the thread bore body, with a set of thread bore body threads, said threads formed to accept a helically threaded insert, for instance with the threads being STI threads. A helically threaded insert is further positioned within the thread bore body threads, with the helically threaded insert providing threads compatible with a selected threaded shaft, for instance SAE threads for an SAE threaded bolt. The barrel nut is configured to fit within a sleeve, such as a generally tubular structural spar, with a circular cross section, as part of an aircraft wing. A barrel segment may be for example, generally cylindrical, or be semi circular in cross section.

In another embodiment, the barrel nut further comprises a generally cylindrical barrel segment and a thread bore body that are formed as a separate structural segments, and from nonidentical material, as would be found in a barrel nut with a floating nut body. The barrel nut may further comprise a thread bore body that incorporates a non-metallic component. The generally cylindrical barrel segment may be cylindrical, and be formed of one or more of steel, alloy steel, Inconel, stainless steel, CRES, plastic, composite, nonmetallic composite, thermoplastic, and resin based composite. Alternatively a cylindrical barrel segment can be formed of one or more of non-metallic components such as plastic, composite, nonmetallic composite, thermoplastic, and resin based composite. In another embodiment, a barrel nut with a cylindrical barrel segment may incorporate a non-metallic component along with a thread bore body that incorporates a non-metallic component and a metallic helical wire insert. It is another embodiment of the disclosure that the barrel nut provides an ultimate tensile strength profile that is significantly increased over a barrel nut does not incorporate a non-metallic component.

The disclosed fastener system may further comprise a fastener with a thread bore internally threaded to accept a helical wire insert; a helical wire insert with an external thread that mates with the internal threads of the thread bore, and internal threads that are compatible with the threads on a shaft; the shaft being externally threaded and capable of being driven by a given torque into the helical wire insert, with the helical wire insert formed as a prevailing torque locking fastener and thus resisting the backing out of the driven insert with a torque greater that the given torque for driving the threaded shaft into the helical wire insert, whereby the helical wire insert serves to lock or secure the fastener at a location determined by the given torque and thus resist backing out of the threaded shaft. In a preferred embodiment, the fastener further comprises a shaft that is a bolt or a stud. In another embodiment, the fastener further comprises a helical wire insert that occupies only a portion of the thread bore, with the remainder of the thread bore being vacant, or occupied by threads formed as part of the nut body. In a particularly preferred embodiment, the fastener claimed is a barrel nut.

It is another embodiment disclosed of a fastener system comprising a barrel nut with a generally cylindrical barrel, a nut pocket and a thread bore; a bolt with a head, a head bearing face, a shaft and a threaded shaft portion; a nut pocket with a helical insert, said helical insert forming the thread bore, said thread bore providing threads compatible with the threaded shaft portion; and said helical insert formed with an anti-rotational shape, whereby threaded rotational insertion of the threaded shaft of the bolt into the thread bore within the nut pocket requires a given applied torque, and the anti-rotation of the threaded shaft requires an anti-rotation prevailing torque. Another embodiment disclosed is a fastener further comprising an anti-rotational helical insert that further comprises spaced apart flat sections on a helical face. Another embodiment includes a fastener that further comprises an anti-rotational helical insert that further comprises a helical insert axis that is not entirely circular in cross section.

The disclosure further embodies a method of attaching a component that comprises providing a fastener with a thread bore internally threaded to accept a helical wire insert; a helical wire insert with an external thread that mates with the internal threads of the thread bore, and internal threads that are compatible with an externally threaded shaft; the shaft capable of being driven by a given torque into the helical wire insert, with the helical wire insert resisting the backing out of the driven insert with a torque greater that the given torque for driving the threaded shaft into the helical wire insert, whereby the helical wire insert serves to lock the fastener at a location determined by the given torque and resist backing out of the threaded shaft.

Another embodiment of the disclosure is a Prevailing torque locking fastener without a free ring of resilient material and without a separate locking disk for providing locking according to a prevailing torque, whether the ring is a retained ring by the structure of the fastener or a captured ring, as would occur with a split locking washer. A further embodiment of the fastener disclosed is a prevailing torque locking fastener with a thread bore containing a helical wire insert that maintains continuous contact with the threads of a threaded shaft along the entire threaded shaft. Another embodiment is of a prevailing torque locking fastener that provides enhanced cycle life compared to a locking fastener that employs a disk of resilient material or that provides enhanced prevailing torque consistency over a projected cycle life compared to locking fastener that employs a disk of resilient material.

Another embodiment of the disclosure is for a prevailing torque locking barrel nut fastener with a helical wire insert, so that the improved barrel nut fastener has a strength profile that is more than about twice the strength profile of a fastener of the same thread bore body material not utilizing a helical wire insert. A further embodiment of the disclosure is the use of helical thread inserts, either locking or free running, in applications that require high strength fasteners, such as 220 KSI rated nuts. Another embodiment of the disclosure is for a prevailing torque locking barrel nut with a helical wire insert that has a mass of less that about 80% of the mass of a barrel nut with equivalent strength profile not utilizing a helical wire insert.

It is yet another embodiment of the disclosure for a method of manufacturing a barrel nut fastener system comprising, forming a generally cylindrical barrel, said cylindrical barrel of a predetermined size to nest within a support sleeve of a structure, and said cylindrical barrel formed to accept a nut body within a nut body seat; providing the nut body that can nest within the nut body seat and that provides a cavity for a threadbore; tapping threads within the threadbore with threads compatible with a helical thread insert; and inserting the helical thread insert within the threadbore of the nut body, and helical thread insert providing a thread bore with internal threads predetermined to be threads compatible with the threads of a threaded shaft.

Another embodiment of the disclosure is for an improved barrel nut comprising a longitudinally extended barrel segment formed with a seat; a thread bore body formed with a thread bore generally perpendicular to the longitudinal axis of the barrel segment compatible with and positionable in the seat of the barrel segment; a stress counterbore concentric with thread bore formed so that threads do not extend to the distal perimeter of the thread bore body; a set of thread bore threads, said thread bore threads formed to accept a helically threaded insert; a helically threaded insert positioned within the thread bore body threads, and the helically threaded insert providing threads compatible with a selected threaded shaft.

### DETAILED DESCRIPTION OF THE INVENTION

Disclosed herein is a new fastener device and associated methods for manufacturing the improved fastener and for securing equipment to an underlying structural support. In particular, disclosed is a locking fastener useful for attaching components in vehicles, engines and the like to structural members, where attachments may be subject to vibrational loosening.

A prevailing torque mechanical fastener utilizes a specified torque or opposed frictional force to lock the fastener in place. Plastic inserts, such as a Vespel insert in a nut, offset locking washers, or crimped deformation fasteners are common examples of prevailing torque locking fasteners. As disclosed herein, the helical insert functions as a new category of prevailing torque locking fastener. The disclosed fastener includes a barrel nut securing a helical wire insert with locking properties, and typically is configured to accept a male threaded fastener, and provide for a desired set of torque tolerances including locking, and unlocking, during installation or removal.

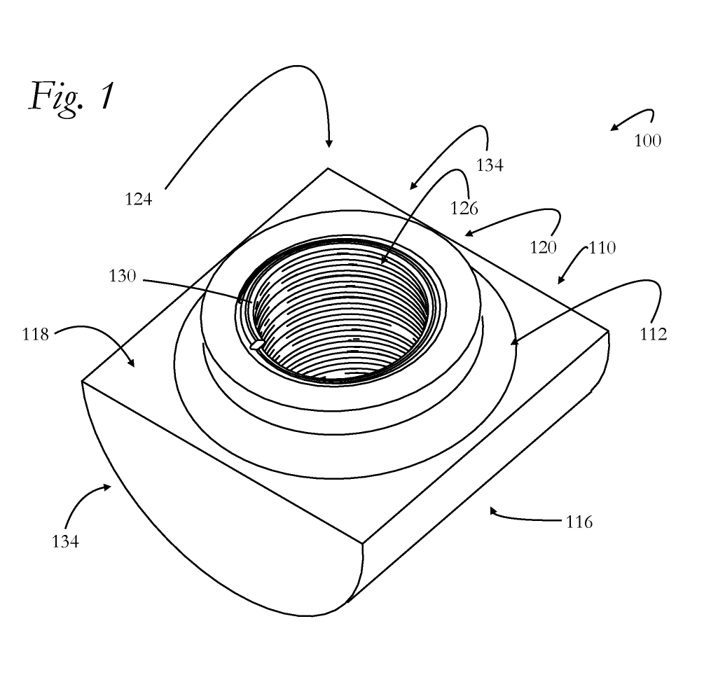

FIG. 1 shows a perspective view of a locking fastener with a helical insert, embodied as a barrel nut. Fastener 100 has a longitudinally extended barrel segment 110 with a seat, 112. In certain preferred embodiments of the fastener, a generally cylindrical thread bore body 120, or a barrel nut chimney, is formed as a separate piece, and the proximal end of the thread bore body 120 is compatible through a press fit or by swaging with the seat of the barrel segment and is therefore positionable in the seat. Alternatively, the thread bore body and barrel segment may be manufactured as a single component. The method of manufacturing the improved fastener disclosed is described further in the discourse that follows.

Inside the thread bore body, a thread bore 124 is formed by drilling, for instance. The thread bore may later be tapped to conform to the desired thread pattern. Threads 126 can be formed to fit typically available standard thread inserts, for example, STI threads. Typically these threads are formed to accept a helically threaded insert, i.e. a helical thread insert (HTI) or helical wire insert. In FIG. 1, a helically threaded insert 130 is shown positioned within the thread bore body threads. Such helically threaded inserts are available compatible with a variety of thread types, and those skilled in the art will recognize that a HTI can be selected with threads compatible with a selected threaded shaft, for instance a SAE threaded bolt or stud.

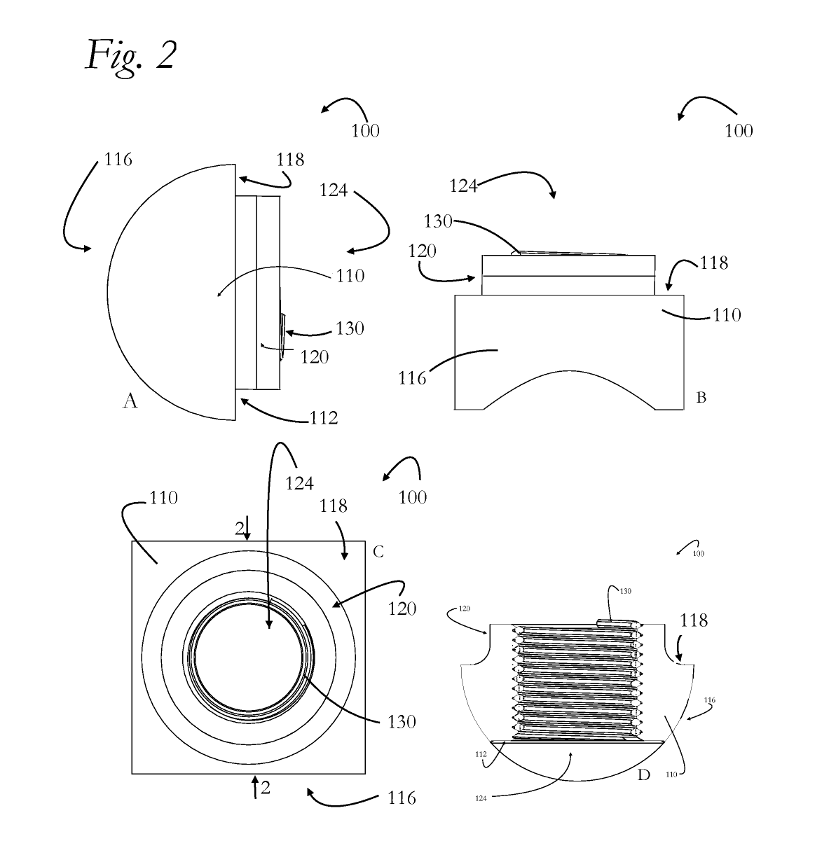

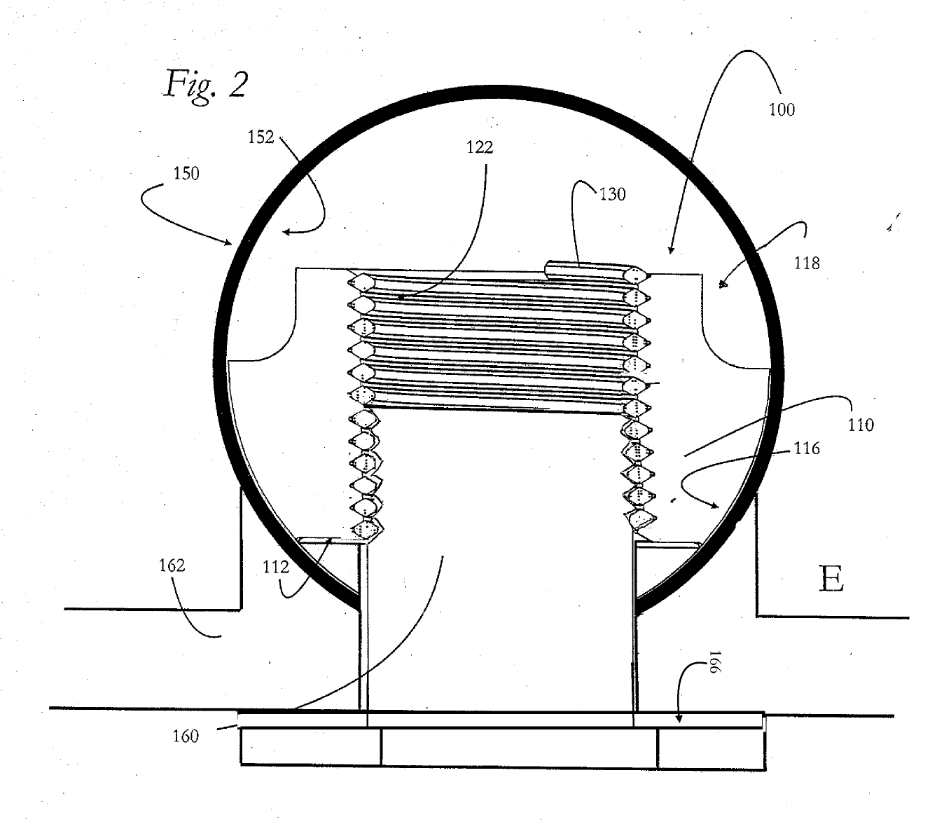

FIG. 2 shows several additional views of the fastener shown in FIG. 1. FIG. 2A shows an end view, FIG. 2B a side view and FIG. 2C a top view of fastener 100. Fastener 100 has a generally half cylindrical barrel segment 110 that will bear against the inner surface of a structural member, such as an aircraft wing spar, that has a bearing surface 116 that is circular, or half circular in cross section. Barrel segment 110 has a flattened upper surface 118. The thread bore body 120 extends above the seat 112, and the upper surface 118 of the barrel segment 110. Helically threaded insert 130 is positioned in the thread bore 124. As shown in FIG. 2, the helically threaded insert 130 does not extend beyond the bearing surface 116 of the barrel segment.

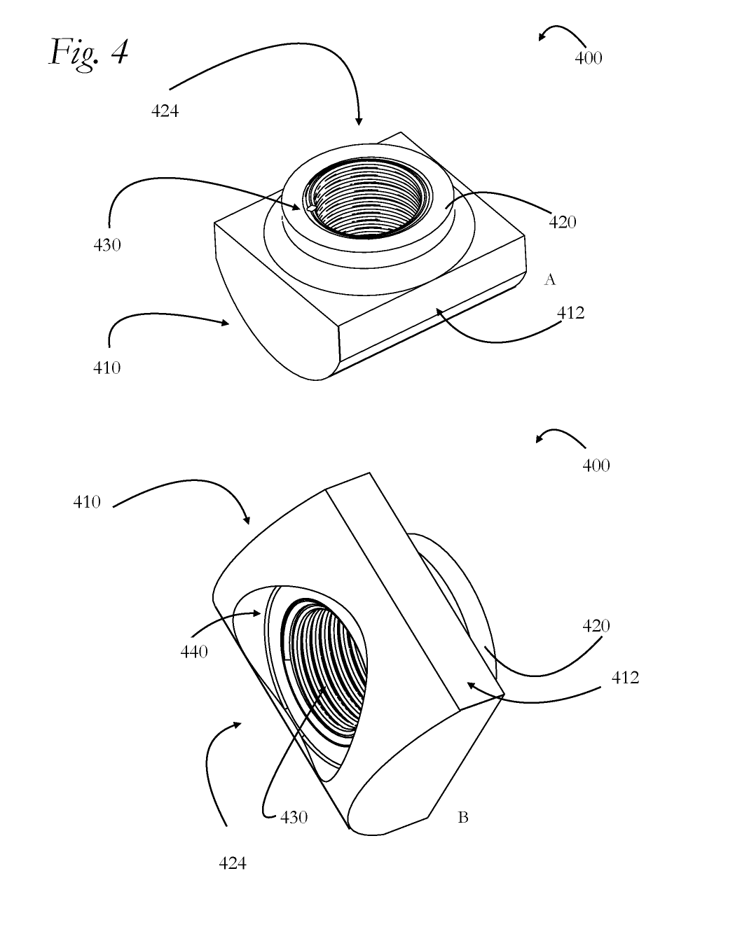

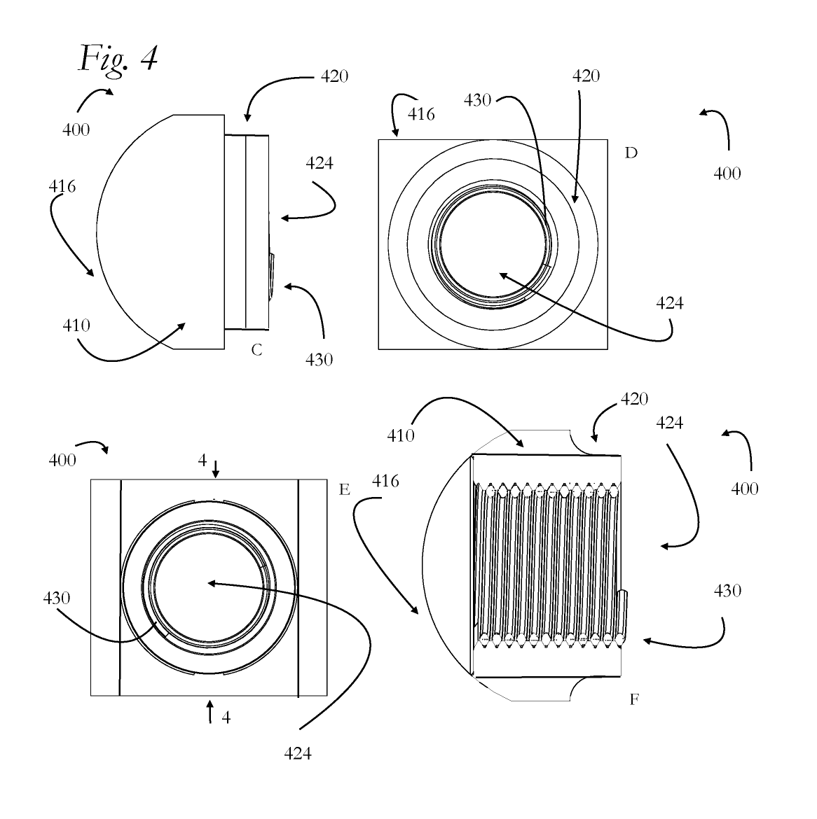

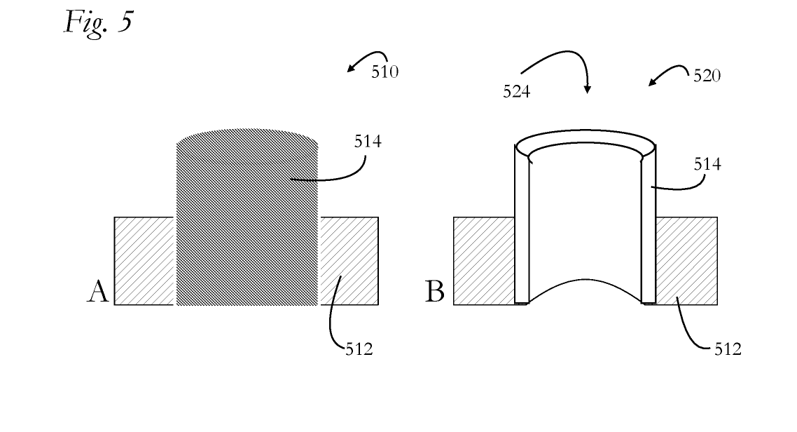

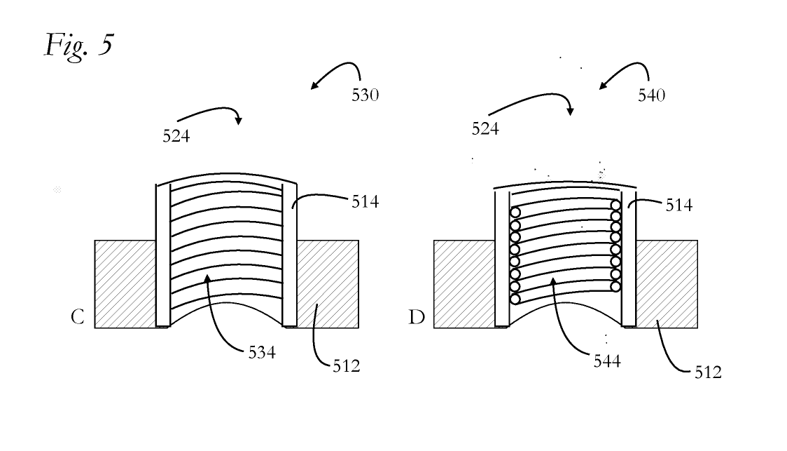

FIG. 2D shows a cross section of fastener 100 along plane 2-2 for FIG. 2C. The barrel segment 110 extends longitudinally away from the thread bore body 120, and is fixed in the seat 112. As shown in FIG. 2, the thread bore body fills the seat in barrel segment 110. Note that fastener 100 is a barrel nut formed with thread bore body 120 and barrel segment 110 from one solid billet, and the seat 112 does not represent a junction of material as would be present in a barrel nut with separate barrel segments and thread bore bodies. See also the fasteners shown in FIGS. 4 and 5 below. In certain preferred embodiments, the barrel segment may be formed of different materials than the thread bore body, or alternatively the barrel segment and thread bore body are a single piece of material. The requirements of the specific application will determine the preferred method of manufacturing the improved fastener.

FIG. 2E shows a transverse cross section of barrel nut 100 inserted along a structural member 150, with a cylindrical bearing surface 152 (circular in cross section). Bolt 160 is protruding from engine mount 162, and is being threadably inserted into barrel nut 100. Thus, barrel nut bearing surface 116 is bearing against the bearing surface 152, and the bolt 160 is driven into the fastener 100, rotation of the bolt engages helically threaded insert 130. The bolt acts to expand the helically threaded insert bearing against the inner surface of the thread bore 122. As the bolt advances into the HTI, additional segments of the helically threaded insert are expanded and further bear with additional force against the thread bore body. Thus, when the bolt is advanced entirely through the helically threaded insert and thread bore body, and is finally torqued to a specified torque, holding the engine mount 162 against the structural member 150, with the barrel nut bearing surface 116 bearing against bearing surface 152, and the bolt head face 166 bearing against engine mount 162.

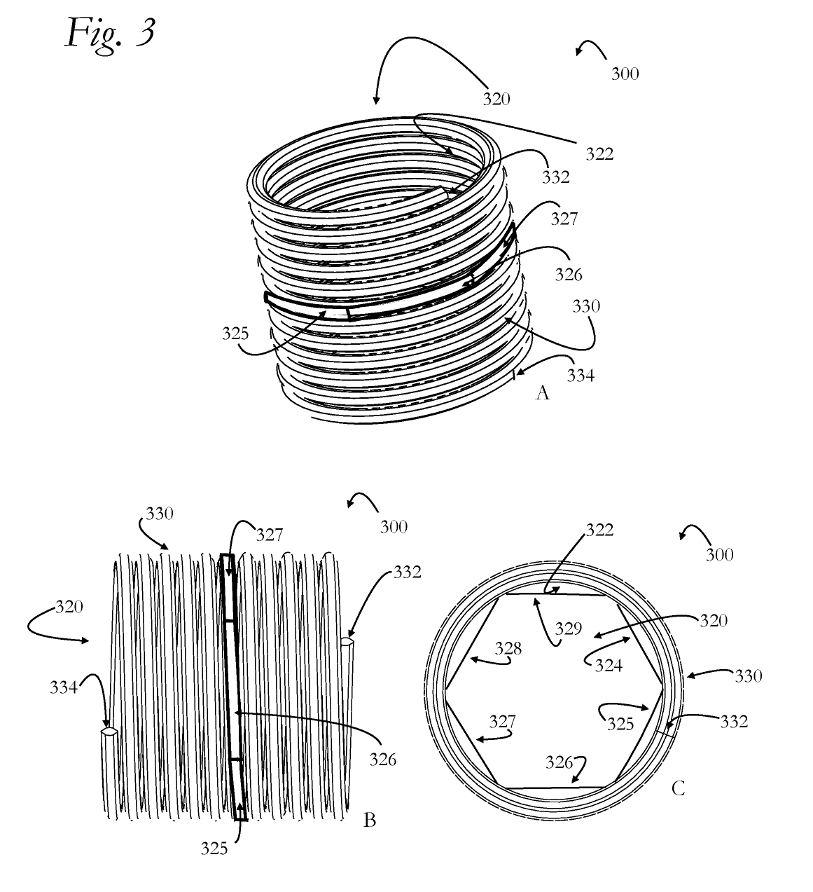

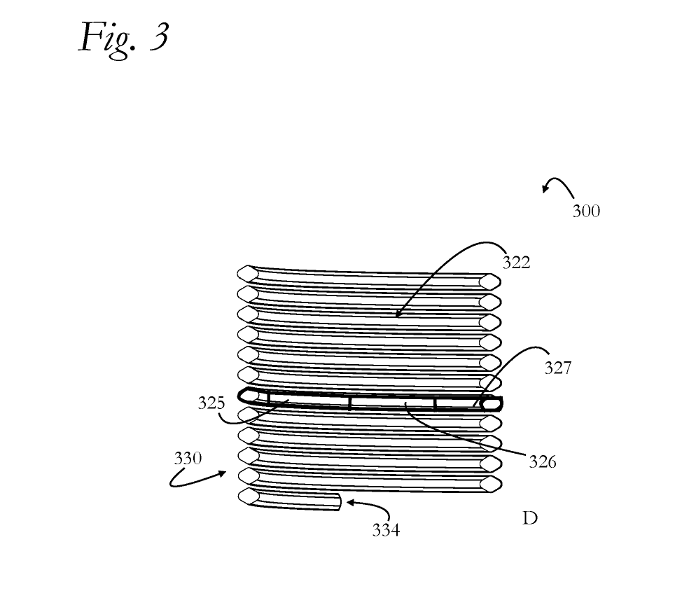

Helical thread inserts can act as prevailing torque locking nuts depending on the HTI used in a particular application. FIG. 3 shows one version of such an insert that will act as a prevailing torque HTI when used with the barrel nut disclosed. FIG. 3A shows a perspective view of such an HTI. Insert 300 is formed of polygonal wire, so that the insert presents an internally threaded threadbore, 320, of threads 322 with a series of HTI faces, 324-329 (for example), which project into the final threadbore. The HTI is formed in the typical application with external threads 330 remaining compatible with an STI thread. The side view in FIG. 3B shows a generally cylindrical HTI, with the threads 330 being interrupted by modified threads, as indicated at 325-327. As shown in FIG. 3, a selected portion of the threads can be modified to change the running characteristics of the internal threads of the HTI (and also to a modifiable extent to the external threads 330). A wide variety of internal threads are available, such as those from Kato Fastening Systems, with differing characteristics of back out and prevailing torque resistance.

An end view of a prevailing torque locking HTI is shown in FIG. 3C, and a cross sectional view in FIG. 3D. From the top view shown in FIG. 3C, the internal threads 322 of threadbore 320 combine to create a generally circular end profile, with the HTI prevailing torque faces 326-329 interrupting the smooth profile of the internal threads. In practice, the characteristics of a helically threaded insert, such as insert 300 installed in a barrel nut such as barrel nut 100, will serve to retain an inserted bolt in position and resist any backing-out of the bolt to a reverse torque specification determinable according to the characteristics of the helical wire insert. Properly installed, the helical insert will bear against both the inserted bolt and the threads within thread bore body, thus resisting the initial back-off movement and further retaining the inserted bolt against a reverse prevailing torque.

Helical inserts have been used for some time in industry for applications that substantially differ from those disclosed, including, for instance, as a means to repair damaged threads. HTI primary purpose is to provide renewed threads after thread damage has occurred. HTI are not generally used at all in nut bodies of common nut body materials, i.e. steel and steel alloys. In those applications where a HTI is inserted into a casting, the casting is most commonly of an aluminum alloy, for instance aluminum alloy engine blocks, and such alloys cannot provide threads stable under high stress or torque. The use of a HTI prior to the present disclosure has been generally disfavored, as the HTI adds additional complexity (another part), and additional cost.

The present disclosure provides a rationale and adaptable design for implementing HTI in nut bodies to provide high strength nuts, with renewable threads, and provides a mechanism for providing a locking or retaining system for nut bodies that previously suffered from a number of limitations. The improved barrel nut disclosed is a heretofore unutilized application of locking HTIs to allow for manufacture of a barrel nut that both provides for a prevailing torque locking fastener, and that increases the useful life of a barrel nut. Importantly, implementation of the improved barrel nut with HTI threads allows for increased strength of the fastener, in excess of what would be predicted based on the previous understanding of the performance of threaded fasteners. The improved fastener even further allows for barrel nuts of new materials, providing weight savings and additional performance enhancements.

A variety of HTIs meeting specifications for threaded fastener systems are provided by manufacturers of helical wire inserts, such as from Kato Fastening Systems, Inc. Helical coil inserts are helically-wound inserts that function in fasteners to provide durable screw threads. Kato brand “CoilThread”™ Inserts are made of cold-rolled No. 304 stainless steel wire (AS7245), work-hardened to a tensile strength above 200,000 psi, and a hardness of Rc 43-50. It should be apparent to those skilled in the art that these thread types are only some of the variety of helical coil inserts. When helical thread inserts are assembled in “STI” (Standard Thread Insert) tapped holes, helical thread inserts can form standardized Unified Coarse (UC) or Unified Fine (UF) threads that conform to National Bureau of Standards Handbook H-28, and meet screw thread standards according to U.S. Federal classification. Helical coil inserts can also be produced that fit a variety of other thread standards, such as, for instance, threads that accommodate UNJ, MIL-S-8879, and male threaded fasteners. Further examples are shown in the 2015 CoilThread Inserts and Tools product catalog of Kato Fastening Systems, Inc. of Newport News, VA.

Barrel nuts are widely used in attaching equipment to an aircraft fuselage. In particular, aircraft jet engines are often attached to the airframe with barrel nuts that include a locking feature. In many applications, a locking feature is required. Specifications for such fasteners commonly provide for a break-away torque limit, and also for a prevailing torque limit. In addition, the same or similar fasteners, with locking features, are used in a variety of situations, such as industrial equipment, farm equipment and other equipment where vibration and motion control is required.

Prior to the present disclosure, the only effective locking or retaining systems available for barrel nuts were a crimped chimney portion or an added disk or collar made of resilient material, such as Dupont Vespel™. These current systems are generally unacceptable because of the expense of the locking inserts and difficulty in installing the locking Vespel insert, and because of the persistent variation found in barrel nuts with crimped chimneys. Both resilient disk inserts and crimped nut bodies require some deformation of the fastener during manufacture, essentially a process of deforming the distal aperture of the nut body. For Vespel inserts, the resilient disk is retained by deforming the disk collar, mechanically restraining the resilient disk. In crimped nut bodies, in particular in crimped barrel nut bodies, the finished thread bore is deformed in order to provide the prevailing torque resistance desired.

An additional difficulty in using such inserts is the need for the bolt fasteners driven into the insert to maintain the specified torque tolerance when in use in an environment that imposes a wide range of temperatures and vibration patterns. As such, a locking mechanism, as described herein as a reverse movement retarder, is considered important.

It is a further embodiment of the present disclosure that the helical thread inserts are not subject to the vagaries of wear commonly encountered with both resilient disk fasteners and with crimped locking fasteners. The fasteners with helical thread inserts experience significantly less permanent alteration when used in service, such that these fasteners can be repeatedly used until a rated cycle life is exceeded. A helical thread insert may in certain applications allow for renewal after a given number of insertions, or cycles of operation in place. When the design life is due to be exceeded, the threaded inserts disclosed herein can be removed and renewed without excessive expense.

FIG. 4 shows a series of views of an alternative barrel nut fastener utilizing a locking helical thread insert, such as that described in connection with FIG. 3. FIG. 4A shows a perspective view of a barrel nut locking fastener 400 with a helical thread insert 430. Fastener 400 has generally cylindrical barrel segment 410 with a semi-circular cross section. The nut body 420 is fixed within seat 412. Inside the nut body, thread bore 424 is formed and has been tapped to conform to the desired thread insert. Helical thread insert 430 is shown positioned within the nut body threads of thread bore 424. FIG. 4B shows an alternative, lower perspective view, revealing the bearing face 416 of the barrel nut segment 410. Counterbore 440 is concentric with the threadbore 424, with a larger diameter, such that the threads of the threadbore or of the HTI do not intersect with the barrel nut bearing face 416.

FIG. 4C shows a side view, FIG. 4D a bottom view, and FIG. 4E a top view of fastener 400. The generally half cylindrical barrel segment 410 of fastener 400 has a bearing face 416 that will bear against the inner surface of a structural member, such as an aircraft wing spar, strut, or other aircraft structural member. FIG. 4F shows a cross section of fastener 400 along plane 4-4 for FIG. 4E. The barrel segment 410 extends longitudinally away from the nut body 420.

As a bolt driven is into the fastener 400, rotation of the bolt would engage helically thread insert 430. The bolt acts to expand the helically threaded insert bearing against the inner surface of the thread bore 424, flexing the helices of the insert, and allowing the threaded shaft to advance. As the bolt advances into the HTI, additional segments of the helical thread insert are thus deformed to further bear against the thread bore body and the advancing shaft. (Note that the HTI shown in FIG. 4 as a matter of presentation does not reveal the prevailing torque segments as clearly as the example shown in FIG. 3) Once the shaft ceases to advance, the conformation action of the locking HTI bears back against the inserted shaft, and retards the reverse threading of the shaft, thus holding it in place against the prevailing torque of the helical thread insert. Thus, when a bolt has been driven into the thread bore of locking fastener 400, the external threads of the bolt force the helical thread insert 430 against the internal threads of thread bore 424. The nature of the helical thread insert is such that reversing the direction of an inserted bolt causes the helical thread insert to expand into the threads of threadbore 424, requiring additional torque to remove the bolt.

Existing locking fasteners are often characterized as either “positive locking” or a “prevailing torque” locking fastener. In a positive locking fastener, the threaded on portion of the fastener, typically a nut, is mechanically held in its prescribed position by some type of mechanical locking barrier. For the nut to be released, or backed off from its specified final position, in a positive locking fastener some mechanical failure must occur, such as shearing of metal, or displacement of a retainer pin.

A prevailing torque mechanical fastener utilizes a specified torque or opposed frictional force to “lock” the fastener in place by retarding its movement. Plastic inserts, such as a Vespel insert in a nut, offset locking washers, or crimped deformation fasteners are common examples of prevailing torque locking fasteners. As disclosed herein, the helical thread insert with a nut body functions as a prevailing torque locking fastener.

The helical wire insert of the current disclosure can be a full substitute for crimped locking fasteners, and minimize the existing problems with starting the fastener on a threaded shaft caused by the tolerances resulting from crimping of the fastener into an oval shape.

It is a further embodiment of the disclosed apparatus or device for use of a helical insert as a locking feature for female self-locking fasteners in lieu of other traditional methods such as crimping (oval and three or more point) in order to deliver more consistent torque performance of the fasteners within the specimens of a given production batch. Such use of the new system provides for a reduced scrap rate of fasteners, better maintainability of installed fasteners, and less risk of material performance issues such as micro crack or hydrogen embrittlement for instance. Implementation of the disclosure allows for the elimination of negative production issues, such as prohibited double crimping, unnecessary additional sorting or the like. While the manufacturing lot rejection rate of crimped fasteners lots can be as much as 20%, experimentation with the manufacture of prevailing torque locking fasteners using a helical wire insert indicates that the lot rejection rate is less than 10%, and is predicted to be less than 1% lot rejection.

The discourse now turns to a discussion of the method of manufacturing a fastener system for a novel type of threaded fastener. A method for manufacturing the disclosed improved fastener system that includes a threaded shaft and a nut body is further provided. In one example, a method of manufacturing a barrel nut fastener system comprises the steps, in an order determined by one skilled in the art, of providing a barrel segment, a nut body with a threadbore, threads for a helical thread insert, inserting a prepared helical thread insert, and providing final finishing and packaging. Such barrel segment and nut body can be formed of metals or metal alloys or include, or be entirely of, non-metallic content.

The steps may include providing a separate threadbore body, i.e. a nut body, with internal threads compatible with a helical wire insert. In a multiple piece barrel nut a cradle with a nut body seat can be formed as a structurally separate unit, and be formed of different materials. For a barrel nut with a floating (removeable, or separate) threadbore body, such threadbore body may be formed of metals or metal alloys or be entirely of non-metallic content, and further be the same or a dissimilar material as the barrel segment and seat.

A subsequent step is that a helical wire insert is installed within the nut body, i.e. in the threadbore. If a retainer clip is specified, and threaded bolts are supplied with the barrel nut, the manufacture follows with connecting such components in a manner that allows for shipping to an installation location, including preassembling some components.

As shown in outline format in FIG. 5, the physical components needed for a complete HTI locking barrel nut include providing a barrel segment and a nut body. A billet 510 may be formed of a preselected diameter and length, and then a barrel segment 512 and nut body 514 formed, for instance by machining to shape (FIG. 5A). In FIG. 5B, a barrel nut blank 520 with an integrally formed nut body 514 is then bored, in order to provide a threadbore 524. Next, as shown in FIG. 5C, the barrel nut blank 530 has the threadbore 524 tapped to form threads, 534, compatible with a helical thread insert. At a later step, shown at 544 in FIG. 5D, a helical thread insert, 540, will be mated with threads formed into threadbore 524 of the interior of the nut body 514. When a helical thread insert, 544, is threaded into the prepared threadbore, if required for a particular fastener, a retainer is provided to keep the HTI in its final location. Thus, the finished fastener, as shown in the previous figures, including FIG. 1, may be completed by adding any final applied finishes, surface treatments or machining.

As shown in FIG. 5, the nut body is part of a single unit with the barrel segment. In alternative embodiments, the nut body may be a separate piece and may be floating, or even pressed into place and therefore in fixed position. For a multiple piece barrel nut, another step in the manufacturing process includes a preferred embodiment of forming a nut body seat that allows for positioning a nut body within the nut body seat. The seat may be formed as part of a molding or casting process, through machining, or possibly drilling. There could be additional steps that may be desirable for particular fastener combinations, such as providing compatible bolts, studs, or shafts to be specially threaded; placing the fastener in packaging that allows for machine handling of the fasteners at the manufacturing or installation location; co-packaging separate components; packaging the fasteners with any necessary tools; including retainer clips in the packaging, or mounting such clips in connection with the barrel nut, whether at the end of the manufacturing process or at some intermediate step.

One step in the manufacturing process includes a preferred embodiment of forming a generally cylindrical barrel, with the cylindrical barrel being of a predetermined size that allows the barrel in combination with the nut body to nest, or slidably advance along and, within a support sleeve of a structure. For instance, a tubular aircraft strut or spar, cross bored for insertion of threaded bolts from the exterior of the strut, in order to mount equipment, such as a wing strut to which an engine is mounted.

The barrel segment has been described herein as generally cylindrical, as struts and spars of aircraft of other vehicles are commonly generally cylindrical in cross section. For purposes of this disclosure, the term “generally cylindrical” should be considered to include any elongated polygon that can hold a nut body in position along a tubular structure while a threaded shaft is inserted into the nut body. Thus the barrel is considered to be the structure that positions the nut body, and prevents the nut body from co-rotating, for inserting a threaded shaft of a bolt or stud. Other variations of elongated polygons could be hexagonal, octagonal, and rectangular barrels that can slidably advance along a generally cylindrical hollow strut. Struts or other structural tubes can also be somewhat flattened, with an oval or pronounced rectangular shape that limits the rotation of an inserted barrel of a compatible cross section. Thus, the present disclosure incorporates the full range of barrel segments just described as being varieties of a “generally cylindrical barrel segment.”

An essential step in the manufacturing process includes forming a threadbore within the nut body. The threadbore provides a cavity that will contain the threads of the complete barrel nut fastener. In certain embodiments, the nut body is formed as part of the barrel, and of the same material. In other embodiments, the nut body is metallic or high strength plastic, and the barrel is formed of a plastic, composite or of a different material than the nut body with the alternative barrel material providing an enhanced performance for the fastener, such as being of less mass, more inexpensive, or providing another advantage, such as being more corrosion resistant. The nut body can be produced by casting, molding, or machining, or some combination of those well-known processes. For instance, a plastic or composite nut body can be molded, and a thread bore drilled to specification, and the nut body machined to mate within the nut body seat of a barrel segment.

When utilizing a helical wire insert, the nut body is most commonly tapped with threads within the threadbore, with threads compatible with a helical wire insert. For instance, a helical wire insert commonly provides external STI (Standard Thread Insert) threads, so a compatible nut pocket is tapped with internal and compatible STI threads.

Following tapping of the thread bore of the nut body, the helical wire insert is threaded into the nut pocket, the helical wire insert thus providing a thread bore with threads that are the predetermined barrel nut threads that are compatible with the threads of the designed threaded shaft. The barrel nut fastener can then be provided with a retainer clip, specially coated or treated, and packaged in accordance with the designated application of the completed fastener.

It should be recognized that the fasteners system disclosed is applicable to a method of attaching components by providing a fastener that includes a thread bore internally threaded to accept a helical wire insert, inserting a helical wire insert with an external thread that mates with the internal threads of the thread bore, and internal threads of the insert that are compatible with an externally threaded bolt and capable of being driven by a given torque into the helical wire insert, with the helical wire insert resisting the backing out of the driven insert with a torque greater that the given torque for driving the threaded shaft into the helical wire insert.

An unexpected result was obtained during the development of the present fastener system and the method of implementing locking fasteners using a HTI. In order to qualify newly developed fasteners for use in aircraft, a performance protocol must be met and confirmed by testing of given lots of fasteners. It is a preferred embodiment of the present disclosure that the use of a helical thread insert provides a much higher fastener strength profile than was expected, and in addition a more consistent repetitive torque profile than could be obtained by any existing qualified fastener. The process of implementation of an HTI with locking feature barrel nut, created a larger diameter thread bore in the fastener nut body. It was anticipated that the larger threadbore might lead to failure of the now relatively thinner nut body. A stainless steel HTI insert installed within the thread bore created the fastener threads that would bear against and carry a threaded shaft (i.e. bolt or stud).

During strength testing of the new fastener structure, it was found that the fastener strength was substantially and unexpectedly increased. In addition, the torque profile of the fastener was significantly more consistent over the 15 cycles of insertion and removal for testing than existing locking fasteners. No existing fasteners exhibit a 15th (terminal) cycle torque that is less than a 25% reduction from the torque required for the first cycle.

A new fastener including a nut body with an HTI threadbore was configured essentially as shown in FIG. 2. In the samples, a nut was formed of 180 KSI material bored to size and then provided with a stainless steel locking insert produced by Kato. The strength to failure of the improved fastener was compared to two aircraft nut samples that are currently utilized by an aircraft manufacturer. The nut “BACN10HC” is formed of 220 KSI material, while the nut “BACN10ZC” is formed of 180 KSI material. As shown in Table I, the tested sample fastener, formed as described in the present disclosure, exhibited an unexpectedly high force required to fail the nut. The 180 KSI material forming the sample nut, with the described insert, had a failure strength that was almost indistinguishable from the BACN10HC nut formed of 220 KSI material. In addition, the locking and breakaway torque forces were not substantially reduced over 15 cycles of tightening and loosening. Thus, not only was the strength performance better, but the improved system described herein provides a fastener that can be repeatedly used without substantially decreased performance.

Thus, the prototype sample 180 KSI nuts performed as well as 220 KSI material nuts. The consistency of the locking torque values over 15 cycles is far superior to the typical performance of Vespel material for the friction locking by prevailing torque material.

TABLE I
Prototype Nut Failure Testing.

| | BACN10HC | BACN10ZC | Improved HTI Nut | |
|---|---|---|---|---|
| | (220 KSI) | (180 KSI) | (180 KSI w/HTI) | |
| UTS | 37,800 | 30,700 | 37,771 | |
| In. Lbs. MIN. | | | (average) | |
| Locking Torque | 150 | 150 | Cycle 1: | 81.22 |
| In. Lbs. MAX. | | | Cycle 15: | 61.88 |
| Breakaway Torque | 18 | 18 | Cycle 1: | 79.11 |
| In. Lbs. MIN | | | Cycle 15: | 63.77 |

An additional series of testing was performed using 220KSI bolts inserted into the fasteners and tested to determine the force necessary to cause the threads to fail under load. Surprisingly, rather than the nuts of 180 KSI material with an HTI, the 220 KSI bolt failed before the 180 KSI nut with HTI. Another test was performed using nuts of Inconel 718 (material rated also at 180 KSI) and 260 KSI bolts with the belief that the failure profile of the nut could be determined. Surprisingly, once again failed the bolts sheared before the threads in the new fastener. The bolt failure occurred at 265 KSI (44% higher than the nuts' rated strength), yet unexpectedly the 180 KSI nut with HTI still did not fail. It is believed that the fastener may still be functional, if the sheared bolt shaft could be removed. Thus, review of the tensile strength performance of the improved fastener system, it is estimated that a barrel nut with a HTI as described will, a prevailing torque locking fastener with a helical thread insert has a strength profile that is about a 50% improvement in UTS, and likely has a UTS that is about a 100% improvement, or more than about twice that of the conventional fastener system.

In the above described testing, the breakaway and prevailing torque tests were performed before the UTS tests. As expected the torque values were very consistent; much more consistent over 15 cycles than any other form of prevailing torque fastener currently available. Barrel nuts manufactured as described are predicted to maintain a locking torque of within about 75% of the average of the first five cycles, over the last of 15 cycles. Similarly, barrel nuts manufactured as described are predicted to maintain a breakaway torque of within about 75% of the average of the first five cycles, over the last of 15 cycles.

The present disclosure is further embodied in a method for manufacturing improved threaded fasteners comprising a nut complementary with a threaded shaft, such as a bolt or stud. The method comprises providing a fastener body that includes a nut body with a thread bore, the thread bore then being internally threaded to accept a helical wire insert, i.e. with an STI thread. Such process can be automated, and either a rolled thread or tapped thread provided. Next a helical wire insert with the characteristics selected for a particular application is chosen, so long as the HTI has an external thread that mates with the internal threads of the thread bore. The HTI may be tanged or tangless, and further provided with locking surfaces or be free-running in certain uses. The HTI provides internal threads that are compatible with the specified threads for accepting an externally threaded shaft, a bolt or stud or other shaft desired for use with the fastener. The complementary externally threaded shaft is thus capable of being driven into the fastener by a given torque by threading into the helical wire insert. The nut body with helical wire insert functions as a nut for fastening parts, with the added benefit of further comprising that the helical wire insert increases the strength of the assembled fastener over the strength of a nut or a threaded shaft made of a single material.

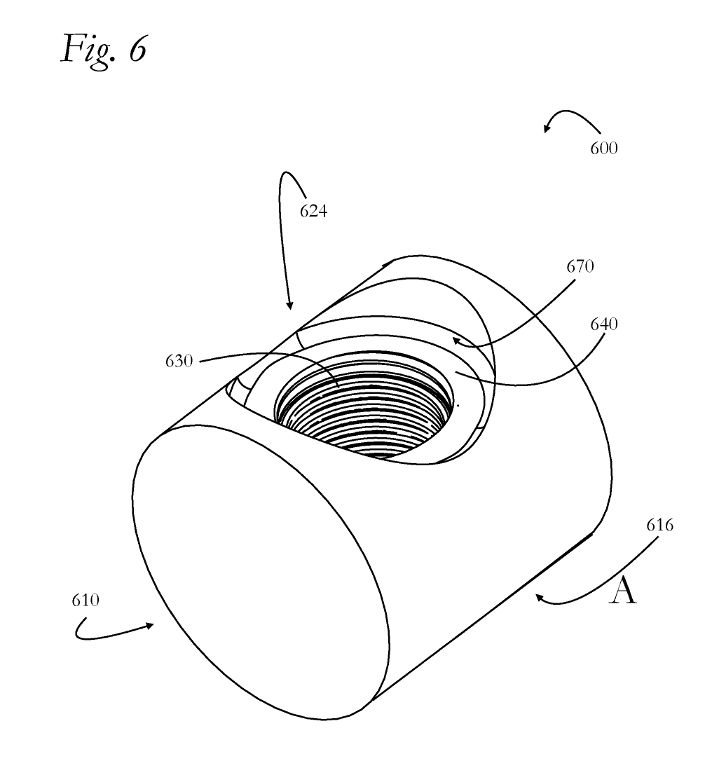

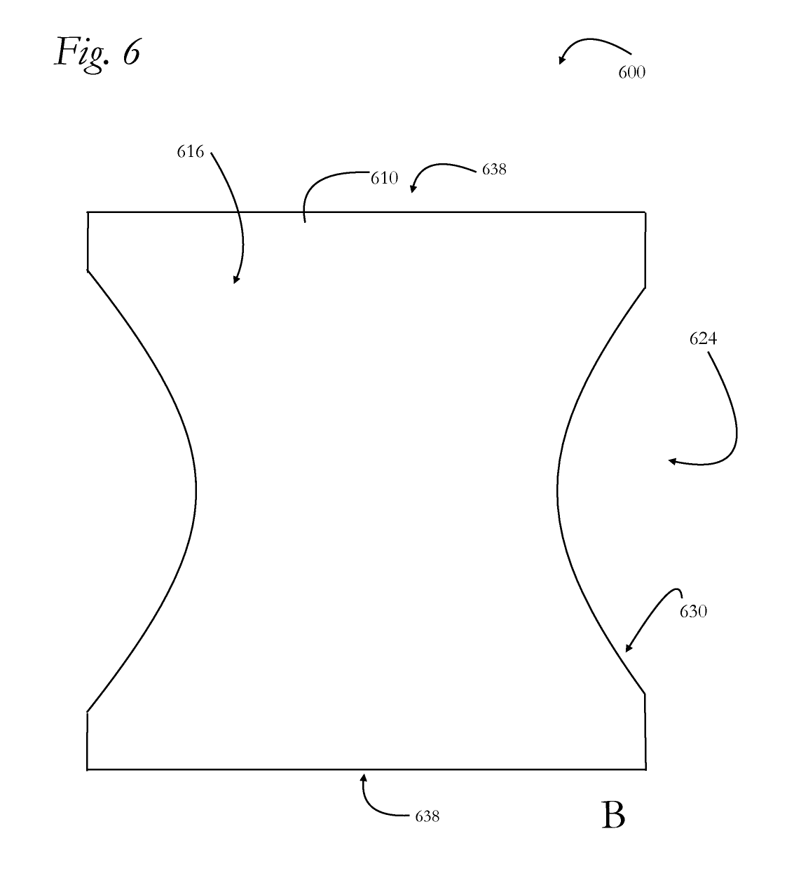

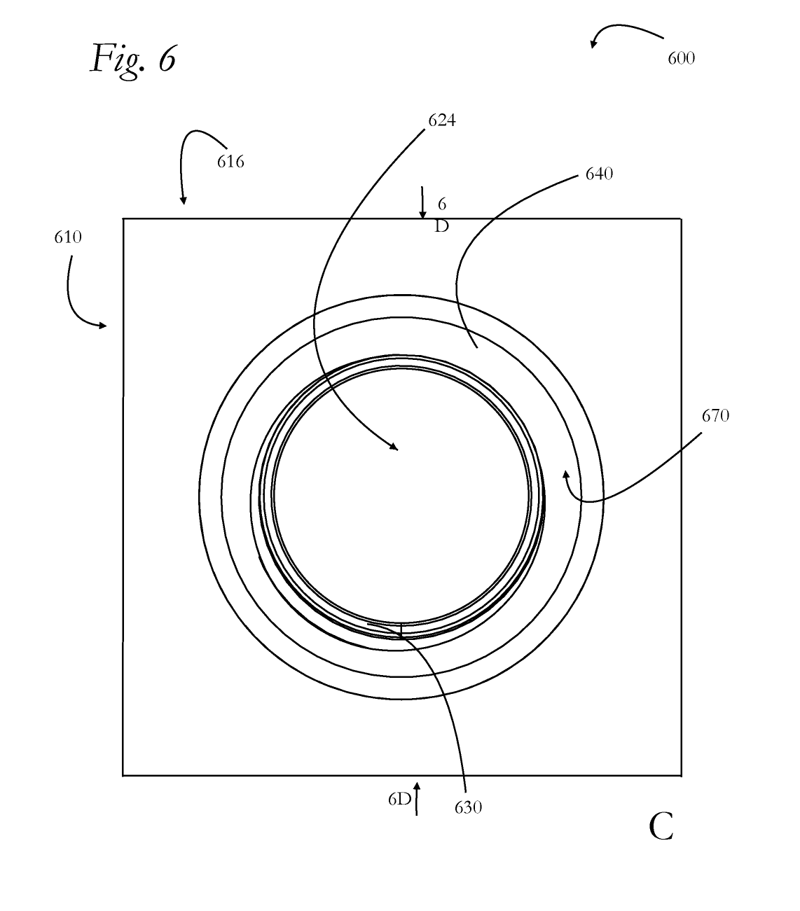

Turning now to FIG. 6, a series of views of an alternative barrel nut fastener utilizing a locking helical thread insert, that is essentially a cylindrical nut body, with a perpendicular thread bore. Such cylindrical barrel nuts are highly adaptable for use in aircraft with composite wings reinforced by longitudinal tubes along the wing. Commonly such reinforcing spars are generally circular in cross section, although other cross sections could be used with compatible barrel nuts, whether rectangular, polygonal, or ellipsoid in cross section. FIG. 6A shows a perspective view of a barrel nut locking fastener 600 with a helical thread insert 630. Fastener 600 has generally cylindrical barrel segment 610 with a generally circular cross section. The nut body is formed within the barrel segment 610 by thread bore 624 being tapped to accept helical thread insert 630. Helical thread insert 630 is shown positioned within the nut body threads of thread bore 624. As discussed, in a preferred embodiment, the helical thread insert 630 is retained within the threadbore. In FIG. 6, a disk shaped retention plate 640, is pressed into a counterbore, and has an internal diameter that is large enough to retain the helical thread insert, but small enough to not interfere with the insertion of a threaded shaft into the helical thread insert.

FIG. 6B shows a side view, and FIG. 6C a bottom view of fastener 600. The generally cylindrical barrel segment 610 of fastener 600 has a bearing face 616 that will bear against the inner surface of a structural member, such as an aircraft wing spar, strut, or other aircraft structural member.

FIG. 6D shows a cross section of fastener 600 along plane 6D-6D for FIG. 6. The barrel segment 610 extends longitudinally away from the nut body 620. The threadbore 624 is internally tapped with threads 632, and placement of HTI 630 into the threadbore create a new, smaller diameter set of internal threads. Commonly the HTI has a margin of flexibility within threads 632, as shown by thread gap 634. The barrel nut 600 has two ends 638 with a circular cross section

Existing locking fasteners are often characterized as either “positive locking” or a “prevailing torque” locking fastener. In a positive locking fastener, the threaded on portion of the fastener, typically a nut, is mechanically held in its prescribed position by some type of mechanical locking feature. For the nut to be released, or backed off from its specified final position, in a positive locking fastener, some mechanical failure must occur, such as shearing of metal, or displacement of retainer pin.

A prevailing torque mechanical fastener utilizes a specified torque or opposed frictional force to lock the fastener in place. Plastic inserts, such as a Vespel insert in a nut, offset locking washers, or crimped deformation fasteners are common examples of prevailing torque locking fasteners. As disclosed herein, the helical insert functions as a prevailing torque locking fastener.

When subject to repeated cycles of applied force and release, as might be experienced by structures forming the wing or within an engine mount, structural components or the fasteners securing such components may develop failures such as fatigue related cracks. Barrel nuts are one type of fastener that may fail after many cycles of stress. Concentration of stress at particular points in a fastener may result in the formation of stress risers (also known as stress raisers). In a fastener that allows for concentration of stress, the fastener may be prone to develop stress risers and fail at a lower load, or shorter life cycle, than is desirable, or might be otherwise expected.

The barrel nut disclosed herein allows for avoiding or relieving the formation of stress risers at locations adjacent to the typical threadbore of a barrel nut with conventional threads. In particular barrel nuts used in vehicles, such as a barrel nut fastener used as an engine mounting barrel nut in an aircraft. Existing barrel nuts are bored or formed with a thread bore that extends to the longitudinal exterior surface of the barrel segment, i.e., the bearing surface of the barrel segment. Subsequently, the thread bore is then tapped to accommodate a threaded shaft. The margin of the tapped threadbore introduces one or more locations of stress concentration. Thus, the tapped threadbore of existing barrel nuts intersects with the bearing surface of the barrel nut, and thus allows for the concentration of stress. The formation of stress risers and the propagation of fatigue cracks occurs about the bearing surface of the barrel nut. The result is premature failure of barrel nuts. The barrel nuts disclosed are further provided with a concentric counterbore adjacent to the threadbore that serves to avoid locations of stress concentration in the barrel nut associated with the threadbore. For further discussion of factors important in determining and limiting the formation of stress risers and fatigue related failure, see Peterson, R. E. “Stress Concentration Design Factors.” John Wiley & Sons (1953).

Another embodiment of the disclosure is for an improved barrel nut with a thread bore body formed with a thread bore generally perpendicular to the longitudinal axis of the barrel segment and a stress counterbore concentric with thread bore formed so that threads do not extend to the bearing face perimeter of the thread bore body. Another embodiment would be for a stress counterbore concentric with the threadbore at the non-bearing face perimeter, so that no threads extend to the perimeter of the threadbore body margin. The stress counterbores contemplated are shown in relation to FIG. 6.

Looking to FIG. 6, counterbore 670 is formed concentrically with the threadbore body. In a preferred embodiment, the threadbore 624 is formed and then tapped with threads compatible with a predetermined helical wire insert, followed by formation (by drilling, milling or other machining process) of the counterbore. After insertion of a HTI in the threadbore, counterbore 670 may relieve inherent stresses introduced during manufacture, or avoid the formation of stress concentration where threads intersect the barrel nut body surface, or reduce the locations where stress risers might form during operation of the overall structure.

It is a further embodiment of the improved barrel nut disclosed that the threadbore body, utilizing a set of threads formed by a helical wire insert, further reduces the formation of stress risers as a result of the HTI distributing the forces on the threads of the threadbore body across a greater contact surface area. The combination of the increased strength of the HTI threaded within the threadbore with the bearing surface counterbore, greatly increases the useful life of a barrel nut installed in an aircraft, or in another high stress application, including a wide range of vehicles.

It is predicted based on the results of failure testing shown above that a HTI barrel nut with counterbore, formed as described, will show an average number of stress cycles until formation of stress risers that is at least 50% greater than a barrel nut that is conventionally formed, such as the current barrel nuts that have conventional threads, and no bearing surface counterbore. It is further predicted that a barrel nut with a helical wire insert and a threadbore counterbore will be able to sustain about 100% more stress cycles prior to failure, than barrel nuts with conventional threads and no bearing surface counterbore.

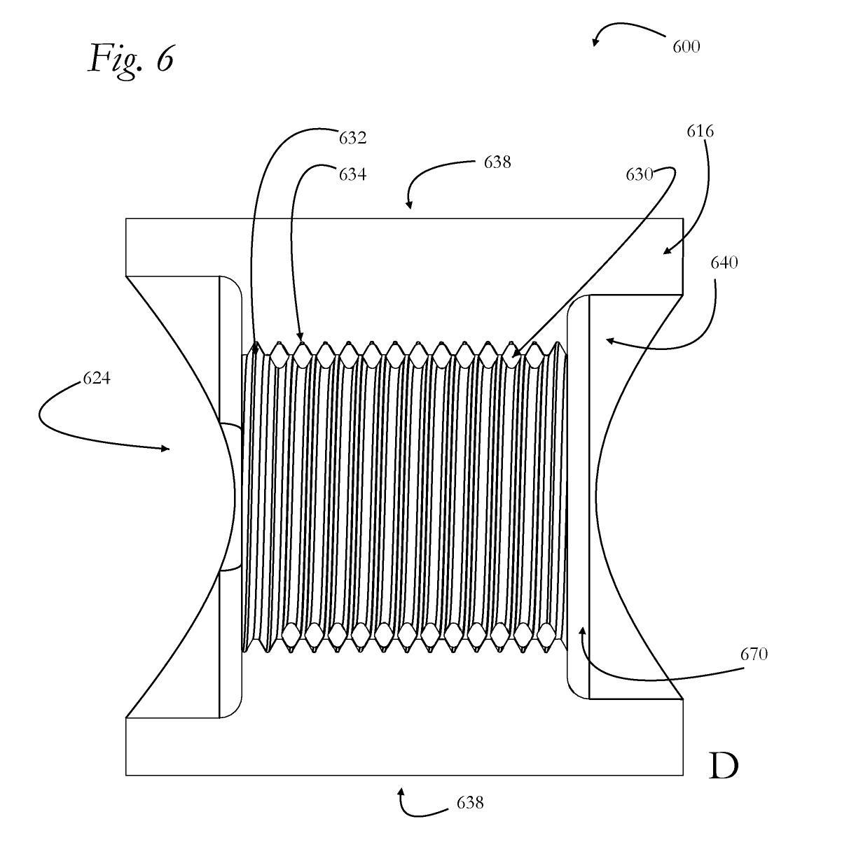

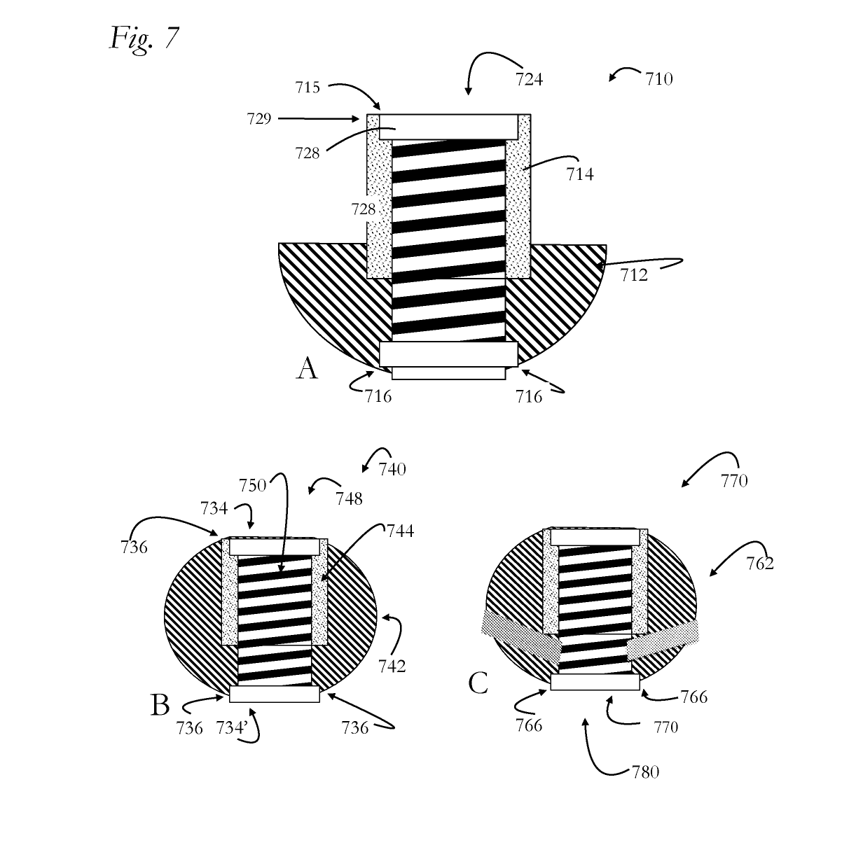

FIG. 7 shows several cross sections of barrel nuts, and improvements contemplated by the present disclosure. FIG. 7A shows a version of a presently common barrel nut. Barrel nut assembly 710 is comprised of a barrel nut body 712, that has a thread bore 724, which will typically be threaded, often by compression forming. The bore body is generally topped by a chimney, 714, along with a planar cap 715. When boring and creating the threads within the thread body, stress risers 716 may be formed at the edge of the barrel nut body. Held within the chimney is the locking ring 728, usually of resilient material such as Vespel, and retained by a crimped lip, 729.

The improved barrel nut disclosed herein provides for eliminating the crimped in Vespel ring, and also provides for a barrel nut that eliminates the formation of stress risers, such as at 716. Barrel nut 740 in FIG. 7B provides a body portion 742, that has a circular cross section, and an opposed chimney 744. Rather than the thread bore shown in FIG. 7A, the thread bore mouth 734 is counter bored to open wider than the thread bore 724, minimizing the formation of stress risers locations such as at 736. Thread bore 748 is formed to accept a helical thread insert 750.

An alternative embodiment is shown in FIG. 7C. The barrel nut 760 is formed with a semicircular cross section with bore body 762 lacking a chimney portion. The thread bore 780 is also counter-bored at stress bore 770 to eliminate the formation of stress risers at 766.

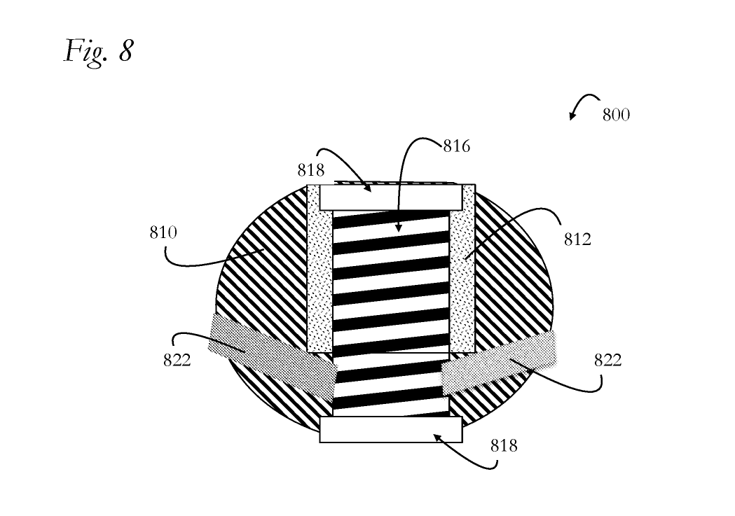

FIG. 8 shows an additional embodiment that provides for barrel nuts for use in aircraft with composite wings. Barrel nut assembly 810 shows a barrel nut with improved strength, with nut body 812 being circular in cross section. The cylindrical thread bore 816, is provided with stress bores 818 to minimize the formation of stress risers. In addition, one or more plugs of resilient material such as Vespel are driven into perpendicular cores 822 that provide for a locking action.

It should be recognized that the fasteners system disclosed is applicable to a method of attaching components by providing a fastener that includes a thread bore internally threaded to accept a helical wire insert, inserting a helical thread insert with an external thread that mates with the internal threads of the thread bore, and internal threads of the insert that are compatible with an externally threaded bolt and capable of being driven by a given torque into the helical wire insert, with the helical wire insert resisting the backing out of the driven insert with a torque greater that the given torque for driving the threaded shaft into the helical wire insert. Additional benefits and features of the fastener system will be apparent to those skilled in the art.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Since certain changes may be made in the above system without departing from the scope of the invention herein involved, it is intended that all matter contained in the above descriptions and examples or shown in the accompanying drawings shall be interpreted as illustrative and not in a limiting sense. Also, all citations referred herein are expressly incorporated herein by reference. All terms not specifically defined herein are considered to be defined according to Webster's New Twentieth Century Dictionary Unabridged, Second Edition. The disclosures of all of the citations provided are being expressly incorporated herein by reference. The disclosed invention advances the state of the art and its many advantages include those described and claimed.

What is claimed:

1. A fastener system comprising
a. a fastener with a thread bore with internal threads for accepting a helical thread insert;
b. a helical thread insert bearing an external thread that mates with the internal threads of the thread bore, and helical thread insert internal threads that are compatible the threads on a threaded shaft;
c. the shaft being externally threaded and capable of being driven by a given torque into the helical wire insert, with the helical wire insert retarding the reverse movement of the driven shaft with a torque greater that the given torque for driving the forward movement of the shaft into the helical wire insert,
whereby the helical wire insert serves to retain the fastener at a location determined by the given torque and resist reverse movement of the threaded shaft.

2. The fastener system of claim 1, further comprising a shaft that is a bolt or a stud.

3. The fastener system of claim 1 that is a barrel nut.

4. A fastener system comprising
a. a barrel nut with a generally cylindrical barrel, a nut body and a nut body thread bore;
b. a bolt with a head, a head bearing face, a shaft and a threaded shaft portion;
c. a nut body holding a helical thread insert, said helical thread insert forming an inner thread bore, said inner thread bore providing threads compatible with the threaded shaft portion; and
d. said helical thread insert formed with an anti-rotational shape,
whereby threaded rotational insertion of the threaded shaft of the bolt into the helical thread insert forming the inner thread bore within the nut body, requires a given applied torque, and the anti-rotation of the threaded shaft requires a predeterminable back-off torque and predeterminable prevailing anti-rotation torque.

5. The fastener of claim 4, further comprising an anti-rotational helical insert that further comprises spaced apart flattened segments on a helical face.

6. The fastener of claim 4, further comprising an anti-rotational helical thread insert that further comprises a helical thread insert that is not entirely circular in cross section.

7. The fastener of claim 4 further comprising a fastener system where retention of the helical thread insert in the thread bore does not require deformation of the nut body.

8. The fastener of claim 4 further comprising a generally cylindrical barrel segment and a thread bore body formed as separable segments, and from nonidentical material.

9. The fastener of claim 4 further comprising a thread bore body that incorporates a non-metallic component.

10. An improved barrel nut comprising
a) a longitudinally extended barrel segment formed with a seat;
b) a thread bore body formed with a thread bore generally perpendicular to the longitudinal axis of the barrel segment compatible with and positionable in the seat of the barrel segment;
c) a stress relief bore concentric with the thread bore formed so that threads do not extend to the distal perimeter of the thread bore body;
d) a set of thread bore threads, said thread bore threads formed to accept a helically threaded insert;
e) a helically threaded insert positioned within the thread bore body threads, said helically threaded insert providing threads compatible with a selected threaded shaft.

11. The barrel nut of claim 10 further comprising a helical thread insert formed with an anti-rotational shape, such anti-rotational shape allowing threaded rotational insertion of the threaded shaft into the helical thread insert upon application of a given applied torque, and the anti-rotation of the threaded shaft requires a predeterminable back-off torque and predeterminable prevailing anti-rotation torque.

12. The barrel nut of claim 11 further comprising an antirotational shape that has none of a free ring of resilient material, a locking disk for providing locking or a mechanically deformed threadbore.

13. A barrel nut of claim 11 further comprising a prevailing torque fastener with a thread bore containing a helical wire insert that maintains a continuous contact with the threads of a threaded shaft along the entire inserted threaded shaft

14. A barrel nut of claim 11 further comprising a prevailing torque locking fastener that provides an extended cycle life compared to a comparable prevailing torque locking fastener that employs a disk of resilient material.

15. A barrel nut of claim 11 further comprising a prevailing torque locking fastener that provides enhanced prevailing torque consistency over a given cycle series compared to locking fastener that employs a disk of resilient material or a crimped nut body.

16. A barrel nut of claim 11 further comprising a prevailing torque locking fastener with a helical thread insert that has a strength profile that is more than about twice the strength profile of a fastener of the same thread bore body material not utilizing a helical wire insert.

17. A barrel nut of claim 11 further comprising a barrel nut with a helical thread insert that has a mass of less that about 80% of the mass of a barrel nut with equivalent strength profile_not utilizing a helical wire insert.

18. The barrel nut of claim 11 further comprising a cylindrical barrel segment that is formed of one or more of steel, alloy steel, Inconel, stainless steel, CRES, plastic, composite, nonmetallic composite, thermoplastic, and resin based composite.

19. A method of manufacturing a barrel nut fastener system comprising
a. forming a generally cylindrical barrel, said cylindrical barrel of a predetermined size to nest within a support sleeve of a structure, and said cylindrical barrel formed to provide a nut body with an axis generally perpendicular to the cylinder axis;
b. tapping threads within the nut body with threads compatible with a helical thread insert;
C) inserting the helical thread insert within the nut body, said helical thread insert providing an internal thread bore with predetermined barrel nut threads compatible with the threads of a threaded shaft.

20. The method of attaching a component comprising providing a fastener that includes a fastener with a thread bore internally threaded to accept a helical wire insert; a helical wire insert with an external thread that mates with the internal threads of the thread bore, and internal threads that are compatible with a threaded shaft; the shaft being externally threaded and capable of being driven by a given torque into the helical wire insert, with the helical wire insert resisting the backing out of the driven insert with a torque greater that the given torque for driving the threaded shaft into the helical wire insert, whereby the helical wire insert serves to retain the fastener at a location determined by the given forward torque and resist backing out of the threaded shaft.
